(19) United States
(12) Patent Application Publication
(10) Pub. No.: US 2009/0166272 A1
(43) Pub. Date: Jul. 2, 2009

(54) Portable Filtration Apparatus with a Remote Monitoring Facility

(76) Inventor: Leslie Donald Selsdon, London (GB)

Correspondence Address: Iandiorio Teska & Coleman, 260 Bear Hill Road, Waltham, MA, 02451, US

(21) Appl. No.: 12/227,956

(22) PCT Filed: May 29, 2007
(86) PCT No.: PCT/GB2007/001978

§ 371 Date: Dec. 3, 2008

(30) Foreign Application Priority Data
Jun. 7, 2006 (GB) 0611254.4

(51) Int. Cl. B01D 35/26

(52) U.S. Cl. 210/90; 210/85

(57) ABSTRACT

Apparatus (2) for filtering a fluid used in a machine, which apparatus (2) comprises a filter (4), a pump (6) for pumping the fluid through the filter (4), monitor means (8) for enabling remote monitoring of functioning of the apparatus (2) and the position of the apparatus (2), and a case (10) which contains the filter, the pump (6) and the monitor means (8), the case (10) comprising a body portion (12), a lid (14), and at least one handle (16), the lid enabling the case (10) to be opened and shut for permitting authorised access to the apparatus (2), and the handle (16) enabling the apparatus (2) to be carried by a person whereby the apparatus (2) is portable for facilitating transportation and installation.

This invention relates to apparatus for filtering a fluid used in a machine. More specifically, this invention relates to portable filtration apparatus with a remote monitoring facility.

There are many different types of apparatus for filtering a fluid used in a machine. Often the apparatus is installed at locations which are remote and/or difficult to access. The known apparatus is often too bulky and/or heavy for easy installation. Also, if the known apparatus should fail, it often occurs that the failure goes undetected, with the result that damage can occur to the machine using the fluid which needs to be filtered.

It is an aim of the present invention to reduce the above mentioned problems.

Accordingly, in one non-limiting embodiment of the present invention there is provided apparatus for filtering a fluid used in a machine, which apparatus comprises a filter, a pump for pumping the fluid through the filter, monitor means for enabling remote monitoring of functioning of the apparatus and the position of the apparatus, and a case which contains the filter, the pump and the monitor means, the case comprising a body portion, a lid, and at least one handle, the lid enabling the case to be opened and shut for permitting authorised access to the apparatus, and the handle enabling the apparatus to be carried by a person whereby the apparatus is portable for facilitating transportation and installation.

The apparatus of the present invention may be used for filtering any suitable fluid for any suitable machine at any suitable location. Thus, for example, the apparatus may be used for filtering a fluid in the form of aviation fuel for a machine in the form of an aircraft engine. Alternatively, the apparatus may be used for filtering a fluid in the form of oil for a machine in the form of an engine. Alternatively, the apparatus may be used for filtering a fluid in the form of a coolant for cooling a machine in the form of an electrical transformer. The coolant may be oil or another fluid.

Preferably, the apparatus is one in which there are two of the filters, and in which the apparatus includes valve means for bringing the filters into and out of operation such that the apparatus operates with a first one of the filters in circuit and such that a second one of the filters is brought into circuit when the first one of the filters becomes not fit for its purpose.

Preferably, the apparatus includes control means for automatically causing the filters to be brought into and out of operation.

Advantageously, the apparatus is one in which the valve means is a solenoid valve, and in which the control means causes operation of the solenoid valve. Other types of valve means may be employed.

Preferably, the pump is a peristaltic pump. Other types of pump may be employed. The peristaltic pump may have three wheels which squeeze the fluid through the pump. The peristaltic pump may be reliable in use, light and relatively inexpensive to manufacture.

The apparatus may be one in which the monitor means comprises sensor means in the case, transmitter means in or on the case for transmitting sensed information from the sensor means, and receiver means at a remote station for receiving the information transmitted by the transmitter means.

The sensor means may be a pressure sensor means for sensing the pressure of the fluid in the case. Other types of sensor means may be employed. Other types of monitor means may be employed.

The handle means may comprise a first handle at one end of the case, and a second handle at one side of the case. The first and the second handles may be retractable and/or folding handles. Generally, the handle means may comprise one or more handles of any suitable and appropriate type or design, and positioned where desired on the case.

The apparatus may include wheels on the case for enabling the apparatus to be pulled by the handle means.

The apparatus may include first and second coupling means for enabling the apparatus to be coupled to inlet and outlet conduits. Preferably the first and second coupling means are first and second quick release couplings. Other types of coupling means may be employed.

The apparatus may include an electricity socket.

The lid is preferably hinged to the body portion of the case.

The apparatus may include locking means for locking and unlocking the lid to the body portion of the case.

The case is advantageously made of a heavy duty plastics material. Any suitable and appropriate type of plastics material may be employed. Other materials may also be employed.

The apparatus may be one in which the or each filter contains a material for removing water from the fluid and/or for removing mutagens from the fluid and/or for removing particles of magnetically-attracted material from the fluid.

The filter may contain one or more of a foam material for removing the water, activated carbon for removing the mutagens, and magnet means for removing the magnetically-attracted material from the fluid.

The foam material is advantageous in that it occupies a large volume of air and thus has a large operative surface area. The foam material may be regarded as having a honeycomb structure. The foam material may be 98% by volume air. The structure of the foam material gives very effective filtration and water absorbing.

The magnet means is able to remove the magnetically-attracted material which may be, for example, metal particles which could otherwise damage the machine. The magnet means may be a disc. The disc may be provided with a plurality of holes. The magnet means may be of any size and/or construction that does not cause undue restriction of the flow of fluid through the apparatus.

The activated carbon is preferably fine particle activated carbon. Such fine particle activated carbon provides a large active surface area for filtering the mutagens.

Preferably, the activated carbon is 44 micron-activated carbon. The activated carbon may be smaller or larger in size than 44 microns.

Generally, increasing the micron size of the activated carbon reduces the active surface area. Reducing the size of the activated carbon may make the activated carbon of such a small size that special handling is required.

The filter may include retainer means for retaining the activated carbon in place.

Where the filter filters mutagens, then the mutagens are retained in the filter where they cause minimum health problems. The activated carbon is a substance having large molecules and these large molecules are able to trap the mutagens. In addition, the activated carbon is a relatively cheap material, and one that is able to be achieved from natural sources. Thus the activated carbon is inexpensive to use so that it is able to meet commercial considerations, and the activated carbon is safe to use so that it is able to meet health and safety considerations. A used filter with the mutagens can be destroyed, for example by burning or any other suitable and appropriate method.

The machine may be substantially all engines such for example as petrol engines, liquid petroleum gas (LPG) engines, and diesel engines. The engines may form part of moving vehicles such for example as road vehicles in the form of cars, lorries, buses and motor cycles. Alternatively, the engines may be in the form of tractors and earth moving equipment. With engines, the fluid will usually be engine oil. The fluid, for example oil, may be used for other purposes.

The machine may alternatively be some kind of static equipment such for example as electrical transformers, electrical generators and pumps. The fluid may be a coolant, for example an oil coolant.

The foam material that may be used in the filter is preferable a woven or non-woven foam material. The foam material may be a polymer material. The foam material may be a foam material which is not hygroscopic. A presently preferred such material is manufactured by the Camelot Company.

The foam material may be in pieces which are positioned in the filter. Alternatively, the foam material and/or the activated carbon may form part of a cartridge which is positioned in the filter. Advantageously, the cartridge is a disposable cartridge so that the remainder of the filter can continue to be used with new cartridges if desired. The cartridge, for example the disposable cartridge, may include a support member for the foam material and/or the activated carbon. The support member may have a plurality of apertures along its length for enabling the fluid to pass through the support member. If desired, the foam material may be positioned around the outside of the support material. In this embodiment of the invention, the foam material is preferably in sheet form, and it is wrapped around the outside of the support member. In an alternatively embodiment of the invention, the foam material may be positioned inside the support member. The foam material may then be in sheet form and/or any form of pieces. The filter may include end screen members for retaining the foam material and/or the activated carbon in the support member.

The filter may include a non-return valve. The non-return valve may be positioned in an end part of the filter.

The filter may be of any suitable and appropriate construction. The filter may have a body which is made of a plastics material. Any suitable and appropriate plastics materials may be employed. The plastics materials may be transparent for see-through purposes or non-transparent if desired. The body of the filter may be made of a metal.

The filter may be one having a separate inlet and outlet. The separate inlet and outlet may be formed for push-on hose connections held in place by clips such for example as jubilee clips. Other formations may be employed so that, for example the separate inlet and outlet may be for receiving screw fittings or snap fittings. The filter may alternatively have a single combined inlet and outlet, and such a filter may be one in which the combined inlet and outlet is an internally threaded aperture for enabling the filter to be a screw-threaded fit to a circuit containing the fluid to be filtered.

An embodiment of the invention will now be described solely by way of example and with reference to the accompany drawings in which:

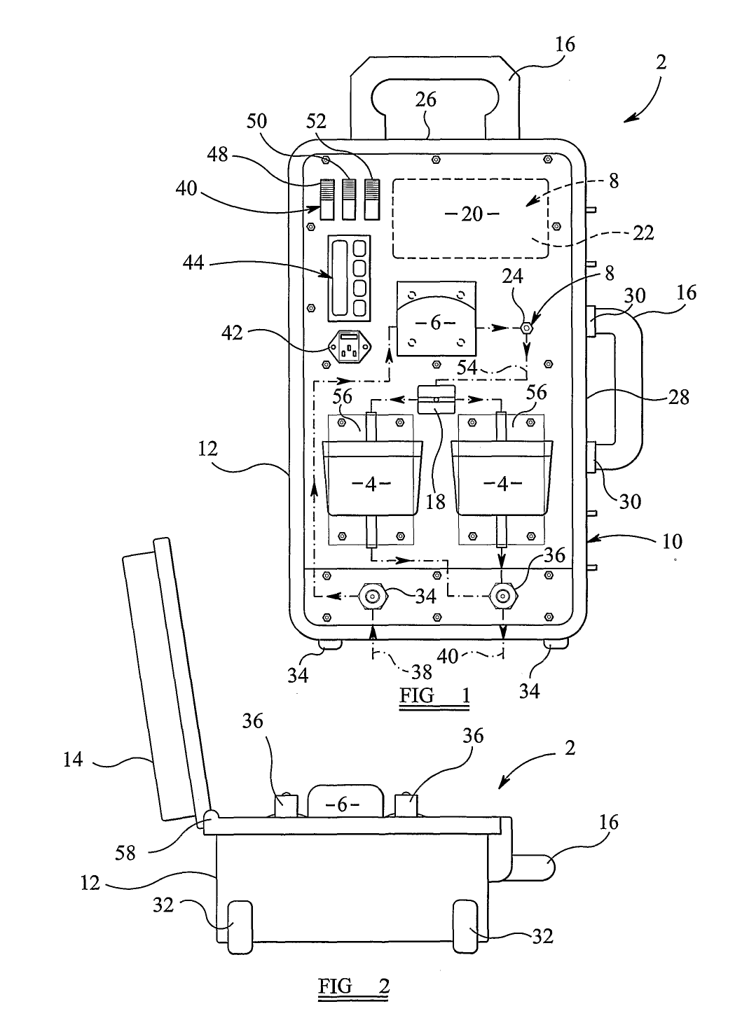

FIG. 1 is a view showing the inside of apparatus for filtering a fluid used in a machine; and

FIG. 2 is an end view of the apparatus shown in FIG. 1.

Referring to the drawings, there is shown apparatus 2 for filtering a fluid used in a machine. The apparatus 2 comprises a filter 4, and a pump 6 for pumping the fluid through the filter 4. The apparatus 2 also comprises monitor means 8 for enabling remote monitoring of the functioning of the apparatus 2 and the position of the apparatus 2. This enables an operative to know where the apparatus 2 is located, and that the apparatus 2 is functioning properly.

The apparatus 2 also comprises a case 10 which contains the filter 4, the pump 6, and the monitor means 8. The case 10 comprises a body portion 12, a lid 14, and at least one handle 16.

The lid 14 enables the case 10 to be opened and shut for permitting authorised access to the apparatus 2. The handle 16 enables the apparatus 2 to be carried by a person. This enables the apparatus 2 to be portable for facilitating transportation and installation of the apparatus 2. Thus the apparatus 2 is easily transported to a desired site for installation. The apparatus 2 is then easily maneuverable for installation at the site, even in awkward positions.

As shown in FIG. 1, there are two of the filters 4. The apparatus 2 includes valve means 18 for bringing the two filters 4 into and out of operation. Thus the apparatus 2 is able to operate with a first one of the filters 4 in circuit, and such that a second one of the filters 4 is brought into circuit when the first one of the filters 4 becomes not fit for its purpose, for example because it is full up with filtered impurities.

The apparatus 2 includes control means (not shown) for automatically causing the filters 4 to be brought into and out of operation. The valve means 18 is a solenoid valve, and the control means is then able to cause operation of the solenoid valve. The control means operates automatically and it may be at a remote installation since all that is required is an appropriate electrical signal to cause operation of the solenoid valve from a power supply 20 mounted on the underside of a panel 22 contained in the body portion 12 of the case 10. Also mounted on the underside of the panel 22 is a global positioning satellite system which forms part of the monitor means 8 and which enables the position of the apparatus 2 to be determined anywhere in the world.

The pump 6 is a peristaltic pump.

The monitor means 8 comprises sensor means 24 which is in the form of a pressure sensor means 24 for sensing pressure of the fluid in the case 10. The monitor means 8 also comprises a transmitter means (not shown) in or on the case 10 for transmitting sensed information to the sensor means 24. The monitor means 8 still further comprises receiver means (not shown) at a remote station (not shown) for receiving the information transmitted by the transmitter means.

As shown in FIG. 1, one of the handles 16 is at one end 26 of the case 10. The other handle 16 is at one side 28 of the case 10. The handle 16 at the end 26 is a retractable handle which extends as appropriate, and which retracts flush with the end 26. The handle 16 is a foldable handle which folds about hinge points 30.

The case 10 includes wheels 32 for enabling the apparatus 2 to be pulled via the handle 16 at the end 26 of the case 10. As can be seen from FIG. 2, the wheels 32 are partially hidden in the body portion 12 of the case 10.

The apparatus 2 includes a first coupling means 34 and a second coupling means 36. The first and second coupling means 34, 36 enable the apparatus 2 to be coupled to external inlet and outlet conduits 38, 40 respectively. The first and second coupling means 34, 36 are quick release coupling means.

The case 10 includes an electricity socket 42.

The apparatus 2 also includes locking means (not shown) for locking the lid 14 to the body portion 12 of the case 10. Any suitable and appropriate locking means may be employed.

The case 10 is made of a heavy duty plastics material. Any suitable and appropriate type of plastics materials may be employed.

The two filters 4 contain a material for removing water from the fluid and/or for removing mutagens from the fluid and/or for removing particles of magnetically-attracted material from the fluid. The filters 4 may thus contain one or more materials as described above.

As shown in FIG. 1, the body portion 12 of the case 10 also houses the panel meter 44 and switches 46. The switches 46 comprise an on/off switch 48, a manual/automatic switch 50 and a switch 52 for causing either the right hand filter shown in FIG. 1 or the left hand filter shown in FIG. 1 to be in the circuit 54 shown in FIG. 1. Preferably, the right hand filter will be the first filter that is in operation, and the left hand filter will be the second filter that comes into operation when the first filter is no longer operating satisfactorily. The reverse arrangement may however be employed. The filters 4 are each mounted on a mounting panel 56 as shown.

As shown in FIG. 2, the lid 14 hinges about a hinge 58.

It is to be appreciated that the embodiment of the invention described above with reference to the accompanying drawings has been given by way of example only and that modifications may be effected. Thus, for example, more than two of the filters 4 may be employed. A pump 6 other than the illustrated peristaltic pump 6 may be employed. The case 10 preferably measures 30 cm wide, 55 cm high and 25 cm deep. The case 10 may however be of other dimensions. Also, the apparatus 2 preferably weighs under 9 kilos when dry, but the weight may vary, for example between 9-19 kilos when the apparatus is dry. Generally, the apparatus 2 is constructed to be light, robust, and easily to hand and manoeuvre. The use of the GPS in the apparatus 2 enables, in real time, a person at a remote control centre which may be many miles away from the apparatus 2 to know how the apparatus 2 is functioning. Thus a person at a control centre would be able to know when the first filter 4 needed changing. The person at the control centre can then automatically bring the second filter 4 into operation so that the apparatus 2 continues functioning satisfactorily. The person at the control centre can then organise the sending of a maintenance man to replace the filter that need replacing. This can be done at a convenient time which is a commercial advantage. The apparatus of the invention may be used for filtering and/or removing a fluid in the form of water, including salt water from lubricating oil, hydraulic oil, electrical transformer oil, and aviation fuel. The filters may hold up to 0.5 litres of water, and they may filter down to 30 micron or less. A wide variety of ferrous contaminants may be removed from the fluid. Various types of fail-safe systems may be employed.

In addition to or alternative to the apparatus using GPS, the apparatus may use the Internet or Bluetooth. The apparatus is able to provide communication, for example to a control station, in real time. This enables equipment in fleets of vehicles, boats, refrigerators, transformers, aircraft and military vehicles to be monitored from a remote station many thousands of miles away. The apparatus of the present invention can be connected to a 12 volt vehicle system, for example through a vehicle cigarette lighter, or the apparatus can be connected to the mains, operating for example at 110 volts or 220 volts.

Various types of coupling means may be employed including male/female couplings, snap on/off couplings and non-drip couplings. In the case of a very large amount of water to be removed from a fluid, four or more of the filters may be employed with two of the filters operating simultaneously. Other numbers and combinations of the filters may be employed.

1. Apparatus for filtering a fluid used in a machine, which apparatus comprises a filter, a pump for pumping the fluid through the filter, monitor means for enabling remote monitoring of functioning of the apparatus and the position of the apparatus, and a case which contains the filter, the pump and the monitor means, the case comprising a body portion, a lid, and at least one handle, the lid enabling the case to be opened and shut for permitting authorised access to the apparatus, and the handle enabling the apparatus to be carried by a person whereby the apparatus is portable for facilitating transportation and installation.

2. Apparatus according to claim 1 in which there are two of the filters, and in which the apparatus includes valve means for bringing the filters in and out of operation such that the apparatus operates with a first one of the filters in circuit, and such that a second one of the filters is brought into circuit when the first one of the filters becomes not fit for its purpose.

3. Apparatus according to claim 2 and including control means for automatically causing the filters to be brought into and out of operation.

4. Apparatus according to claim 3 in which the valve means is a solenoid valve, and in which the control means causes operation of the solenoid valve.

5. Apparatus according to claim 1 in the pump is a peristaltic pump.

6. Apparatus according to claim 1 in which the monitor means comprises sensor means in the case, transmitter means in or on the case for transmitting sensed information from the sensor means, and receiver means at a remote station for receiving the information transmitted by the transmitter means.

7. Apparatus according to claim 6 in which the sensor means is a pressure sensor means for sensing pressure of the fluid in the case.

8. Apparatus according to claim 1 in which the handle means comprises a first handle at one end of the case, and a second handle at one side of the case.

9. Apparatus according to claim 8 in which the first and second handles are retractable and/or folding handles.

10. Apparatus according to claim 1 and including wheels on the case for enabling the apparatus to be pulled via the handle means.

11. Apparatus according to claim 1 and including first and second coupling means for enabling the apparatus to be coupled to external inlet and outlet conduits.

12. Apparatus according to claim 11 in which the first and second coupling means are first and second quick release couplings.

13. Apparatus according to claim 1 and including an electricity socket.

14. Apparatus according to claim 1 in which the lid is hinged to the body portion of the case.

15. Apparatus according to claim 1 and including locking means for locking and unlocking the lid to the body portion of the case.

16. Apparatus according to claim 1 in which the case is made of a heavy duty plastics material.

17. Apparatus according to claim 1 in which the or each filter contains a material for removing water from the fluid and/or for removing mutagens from the fluid and/or for removing particles of magnetically-attracted material from the fluid.

18. Apparatus according to claim 17 in which the filter contains one or more of a foam material for removing the water, activated carbon for removing the mutagens, and magnet means for removing the magnetically-attracted material from the fluid.
